(19) United States
(12) Patent Application Publication
(10) Pub. No.: US 2004/0216578 A1
(43) Pub. Date: Nov. 4, 2004

(54) Portable punch system

(76) Inventors: Kevin L. Corcoran, Mission Viejo, CA (US); Robert E. Workman, Mapleton, UT (US); Trevor Freeman, Costa Mesa, CA (US); Guorui Deng, Dong Guan City (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/695,631

(22) Filed: Oct. 27, 2003

Related U.S. Application Data
(60) Provisional application No. 60/421,224, filed on Oct. 25, 2002.
(60) Provisional application No. 60/442,261, filed on Jan. 24, 2003.

(51) Int. Cl. B26F 1/14

(52) U.S. Cl. 83/684

(57) ABSTRACT

Disclosed is a portable punch, which includes a handle end and an opposite punch holding end. The portable punch has a grip that helps to orient the portable punch when in use. The grip may take the form of a sleeve with the thickness of the plastic sleeve being approximately equal to one-half of the distance that the punch die extends from the cutting side of the portable punch.

### RELATED APPLICATIONS

This application relates to provisional patent application 60/421,224 filed on Oct. 25, 2002, and provisional patent application 60/442,261 filed on Jan. 24, 2003, both of which are incorporated by reference herein as if set forth in their entirety.

### FIELD OF THE DISCLOSURE

The present invention relates to die presses and, more particularly, a portable punch that may be used to punch shapes into and out of a medium, such as paper.

### BACKGROUND OF THE DISCLOSURE

Die presses that are used with dies are currently utilized to cut shapes out of certain mediums, such as paper, and these systems are used in educational settings as well as by hobbyists in the arts and crafts markets. In addition, people who create and maintain scrapbooks utilize die presses and punches.

Current punches have a U-shaped configuration with the die opposing a cutting pad or a mating component. One limitation of the presently available punches is that the throat of the U-shaped device limits the depth that the punch may be located on the medium to be cut. For example, if an 8½×11 inch piece of medium is being utilized and a punch has a 3-inch throat, then only a 3-inch perimeter around the medium may be cut by the punch.

### SUMMARY OF THE DISCLOSURE

Disclosed is a punch, which includes a cutting component that is configured to a shape, a cutting component housing that houses the cutting component, and wherein the cutting component extends beyond the cutting component housing, and a handle component that extends from the cutting component housing for positioning the punch. The punch may be positioned on a cutting medium, such as paper, plastic, leather, or the like to cut the cutting component configured shape from the cutting medium.

The cutting component is made from steel rule in one aspect of the disclosure, with an enlarged area located adjacent to the cutting component. In addition, the handle component may include indentations to properly orient the punch and to locate the user's fingers during use.

In another aspect of the disclosure, disclosed is a punch assembly, which includes a handle end and an opposite punch holding end, the punch holding end holding a punch die which extends beyond a cutting side of the punch holding end, and the handle end includes a sleeve with the thickness of the sleeve being approximately equal to one-half of the distance that the punch die extends from the cutting side of the punch holding end.

### BRIEF DESCRIPTION OF THE DRAWINGS

The invention will now be described in greater detail with reference to the preferred embodiments illustrated in the accompanying drawings, in which like elements bear like reference numerals, and wherein:

FIG. 1 is a perspective view of a portable punch according to the present disclosure;

FIG. 1a is a close up view taken from FIG. 1;

FIG. 2 is a front view of the portable punch according to the present disclosure;

FIG. 3 is a top cross-sectional view taken from line A-A from FIG. 2;

FIG. 4 is a top plan view of the portable punch according to the present disclosure;

FIG. 5 is a side cross-sectional view taken from line A-A of FIG. 4;

FIG. 6 is a side elevational view of the paddle punch according to the present disclosure;

FIG. 7 is a cross-sectional view taken from line A-A of FIG. 6;

FIG. 8 is a cross-sectional view of line B-B taken from FIG. 6;

FIG. 9 is a side elevational view illustrating the paddle punch system, including the paddle punch, a cutting medium, such as paper, and a cutting pad; and

FIG. 10 is a perspective view of a second embodiment of the disclosure;

FIG. 11 is a top view of the second embodiment;

FIG. 12 is a bottom view of the second embodiment;

FIG. 13 is a first side view of the second embodiment;

FIG. 14 is a second side view of the second embodiment;

FIG. 15 is a first end view of the second embodiment;

FIG. 16 is a second end view of the second embodiment; and

FIG. 17 is a perspective view of a third embodiment.

### DETAILED DESCRIPTION OF THE DISCLOSURE

Disclosed is a portable punch which may be used to cut shapes out of a cutting medium, such as paper, plastic, leather, or the like, so that the shapes may be used to accentuate or design a particular item, such as a scrap book, gift card, or the like. The advantage of the portable punch of the present disclosure is that the cutting location on the medium is not limited to the dimensions or configuration of the punch and the portable nature of the punch disclosed herein allows shapes to be cut out of mediums at any location on the cutting medium as directed by the user by locating the portable punch at the desired location on the medium to be cut.

As will be further described below, the portable punch is placed against a cutting medium which, in turn, is placed against a cutting pad. Then the portable punch is held down against the cutting medium so that when a punch die located in the portable punch is forced into and beyond the cutting medium, the result is a desired shape being cut out of the medium. In one embodiment, pressure is exerted onto the portable punch by a hammer. The hammer in one embodiment may include a soft or plastic tip so as not to distress or distort the portable punch or the punch die located in the portable punch when being struck by the hammer.

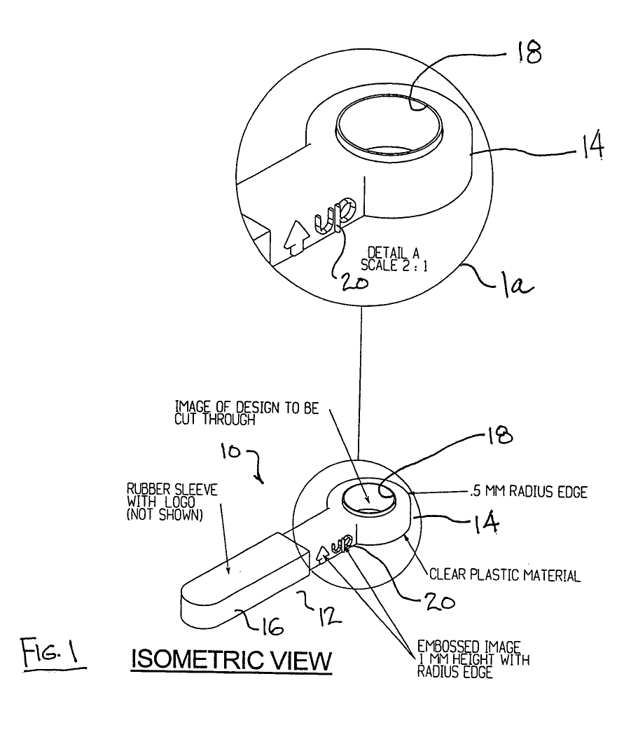

As illustrated in FIG. 1, a portable punch 10 includes a handle end 12 and an opposite punch holding end 14. The handle end 12 in one embodiment includes a sleeve which may be made of a rubber, plastic, elastomeric, or other material. The sleeve 16 provides a gripping surface for the portable punch and, as further described below, provides as a stop when the punch is inserted into the cutting medium and the pad. In addition, the sleeve, if made of a shock absorbing material, may absorb shock from the hammer striking the punch.

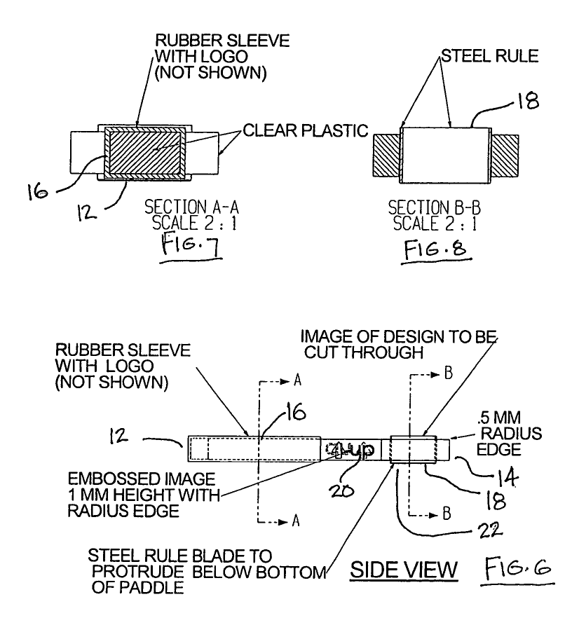

In this embodiment, along one side of the portable punch is indicia 20 which indicates to the user how to orient the portable punch during use so that the sharp edge of the punch die is located against the cutting medium so that the cutting side 22, as shown in FIG. 6, is placed properly on the cutting medium. The punch die 18 has a sharp cutting edge on its cutting side 22.

FIGS. 1-8, illustrate the different views and cross-sectional views of the portable punch and its components. For example, view 1a of FIG. 1 illustrates how the punch die 18 extends beyond the portable punch on the top side when in the “up” position so that force may be applied directly to the punch die 18 and transferred through the punch die 18 to the cutting edge of the punch die, which is placed on the cutting medium. The sleeve 16 may include a logo or slogan, however, the logo or slogan would only be added onto the sleeve surfaces that are not adjacent to the cutting medium unless the overall height of the sleeve and the logo or slogan were taken into account, the importance of which will be further described below. The punch holding end 14 has a radius outer edge as viewed from the top with the proper dimension to accommodate for the size and shape of the punch die 18. In the example shown, the punch die 18 is cylindrical in shape and the resulting cutouts from the cutting medium would be a circle. Nevertheless, the punch die may take a variety of configurations, samples of which may include all geometric shapes such as squares, rectangles and triangles, as well as other shapes such as stars, apples or the like.

The punch die is made a steel rule material, which typically comes as a roll of material. Therefore, the proper amount of steel rule is cut from the roll, the steel rule is bent into the desired configuration, and then the ends of the steel rule are aligned and welded together. This allows for a uniform shape to be cut from the cutting medium without any interruptions in the resulting shape cut from the cutting material.

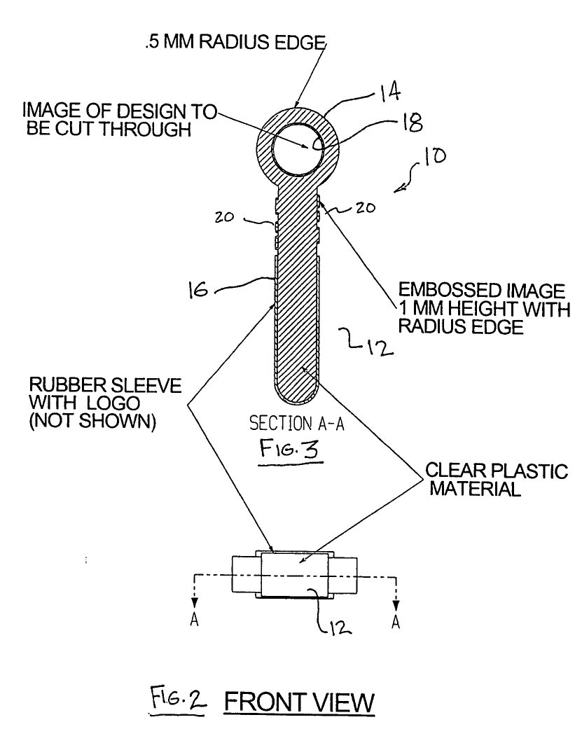

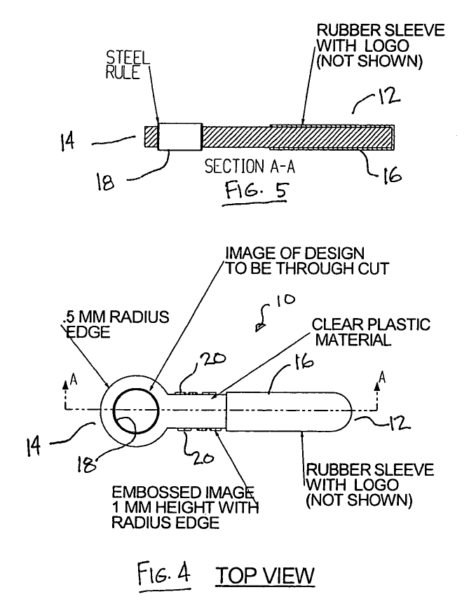

FIG. 3 illustrates a cross-sectional view taken from FIG. 2 and shows the sleeve 16 extending towards the punch holding end 14, yet the sleeve 16 stops prior to the indicia 20 located on the side of the portable punch 10. Also, it is shown that indicia 20 may be located on both sides of the portable punch 10 to help the user to properly orient the portable punch when in use. Likewise, FIG. 4 illustrates the same orientation of the elements of the portable punch 10 of the present disclosure.

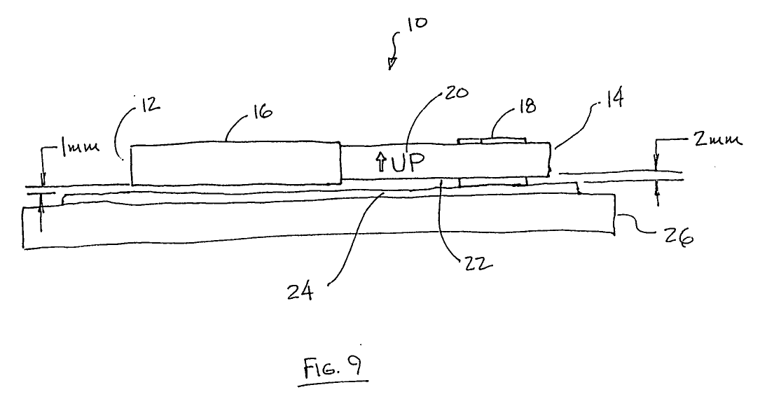

FIG. 7 illustrates a cross-sectional view taken from FIG. 6, wherein the sleeve 16 is shown surrounding a portion of the portable punch 10 at the handle end. As will be further described below, the thickness of the sleeve 16 is generally uniform so that the cutting depth may be controlled during use of the portable punch.

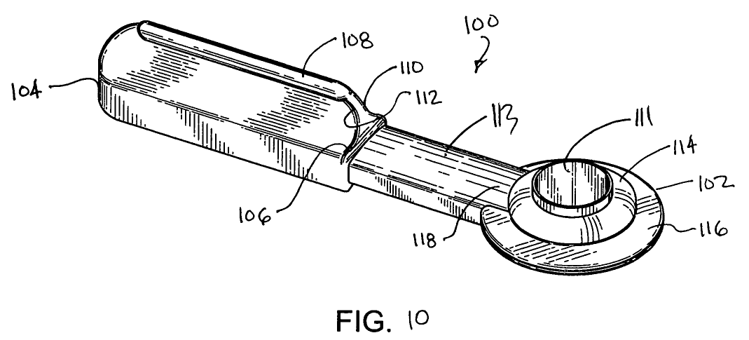

FIG. 9 illustrates the portable punch 10 in use, wherein the portable punch 10 is placed in its proper orientation by utilizing the indicia 20, which indicates the top and the bottom of the portable punch 10. The bottom side of the portable punch is also referred to as the cutting side 22. The portable punch is placed in its proper orientation against the cutting medium 24, which may include paper, plastic, leather or any other material which is desired to be cut. FIG. 9 illustrates the portable punch prior to the punch die 18 penetrating the medium 24. In this exemplary embodiment, the punch die 18 extends approximately two millimeters from the cutting side 22 so as to allow for an adequate length of the punch die 18 to extend through the cutting medium 24 and into a resilient cutting pad 26. When pressure is applied to the punch die 18 via a hammer or other tool, the punch die 18 penetrates through the cutting medium 24 and against and possibly into the cutting pad 26. Nevertheless, the thickness of the sleeve 16 is adapted to provide a one millimeter gap between the outer surface of the sleeve and the cutting medium 24 prior to penetration of the punch die 18 into the cutting medium 24. Therefore, the sleeve 16 acts as a stop to limit the penetration of the punch die 18 into the cutting medium 24 and the pad 26. The handle end 12 of the punch 10 and the sleeve 16 help to keep the punch die 18 parallel during its cutting action with the cutting medium 24. In the example shown, the punch die 18 would penetrate through the cutting medium and the cutting pad 26 approximately one millimeter, since two millimeters (distance of the punch die extension from cutting side 22) minus one millimeter (distance from the outer surface of sleeve 16 to medium 24) equals one millimeter (penetration into the cutting medium 24 and the cutting pad 26). Of course, the dimensions could be modified to allow for less or more penetration of the punch die 18 depending upon the cutting medium 24 or other requirements.

The cutting pad 26 may be made from closed cell foam or other material and the pad 26 must be relatively resilient so as to provide spring-back to the original shape of the pad after the punch die 18 has penetrated the cutting medium 24.

In one embodiment, a hammer with a flat striking head is modified by gluing a cylindrical shaped piece of nylon material onto the flat head of the hammer. The nylon tipped hammer provides a means for applying pressure onto the top portion of the punch die 18 without distressing or distorting the punch die 18. The nylon tipped hammer also provides vibration dampening and sound dampening, both of which are features that may be desirable in the consumer market.

The portable punch 10 may be molded from an acrylic material or from a clear ABS (Acrylonitrile Butadiene Styrene), and the portable punch 10 is preferably injected molded. The sleeve 16 on the handle end of the punch may be made from a rubber material that is liquid when heated and the handle end of the punch may be dipped into the liquid rubber and when the rubber cools the resulting sleeve 16 is produced. This rubber material may be a PVC (Polyvinyl Chloride) or a polyproprene material. Of course, other materials may be used to create the sleeve over the handle end of the punch.

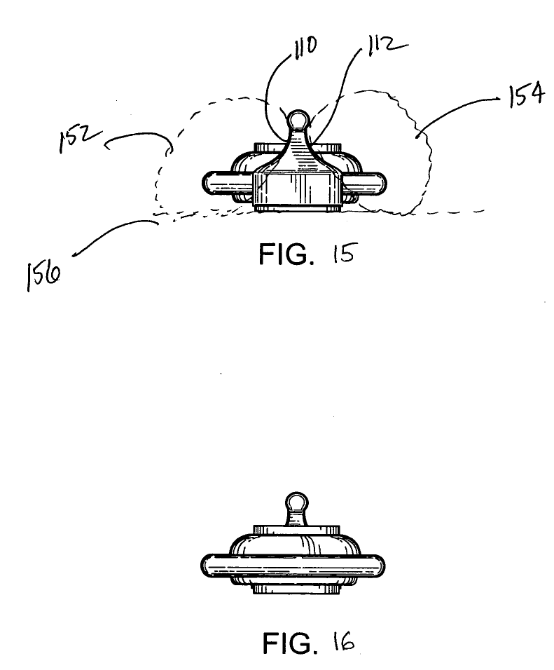

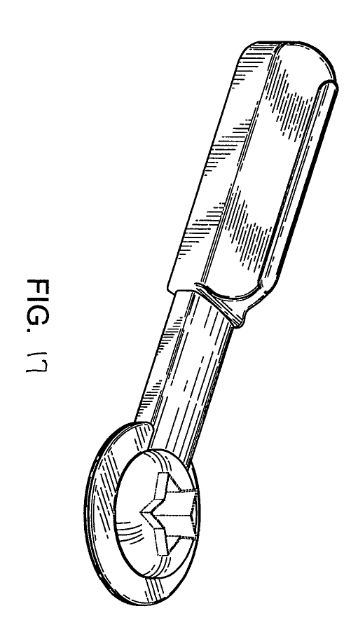

Another embodiment is shown in FIGS. 10-16, wherein the portable punch 100 includes a cutting component, or cutting punch 111, which is configured to a desired shape, shown here as a cylinder. The portable punch 100 includes a punch holding end 102 and a handle end 104. The handle end includes a top portion 106 and a rib portion 108 that extends from the top portion 106 and extends the length of the handle 104. The rib portion 108 includes two opposing concave surfaces 110 and 112, or indentations, so as to define a gripping area for the user to orient the portable punch on the cutting medium at the desired cutting location and for the user to place their fingers in the indentations.

Further, the rib portion 108 prevents the users from orienting the portable punch in the wrong position on the cutting medium. For example, if the user placed the portable punch upside down onto the cutting medium, the raised rib 108 would lift the handle off of the cutting medium at such a height that the portable punch would tip to one side or the other onto the cutting medium rendering the portable punch to be non-usable. Further, the user would recognize that the portable punch is not positioned in its proper orientation. Therefore, rib 108 provides a gripping area for the user's fingers and automatically suggests to the user the proper orientation of the portable punch so that the cutting surface of the steel rule dies is properly oriented against the cutting medium prior to a cut.

Further, the die holding end includes a raised area 114 which extends around the steel rule die. The raised area 114 tapers into a generally flattened area 116. The raised area 114 provides extra strength around the steel rule die in the event that any missed hits of the hammer occurs around the steel rule die. Therefore, the raised area 114 deflects or absorbs the forces from the miss-hits from the hammer, or other striking object, and provides a stiffening area around the steel rule die.

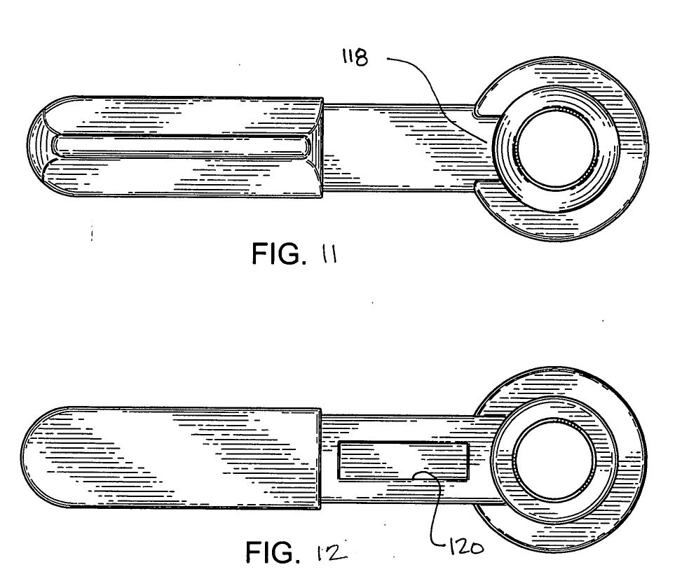

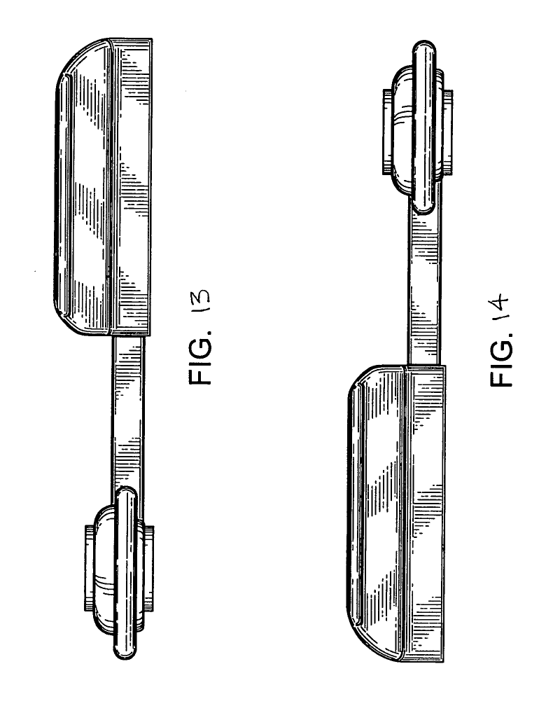

Further throat area 118 has an increased thickness to absorb any forces from miss-hits of the hammer or other striking object against the steel rule die. In addition, as shown in FIG. 12, a recess 120 is shown in the underside of the throat area to prevent warpage of certain plastic materials during the manufacturing process when the plastic cools and shrinks. Further, cavity 120 allows for less material to be used during the manufacturing process.

As shown in FIG. 15, the indentations 110 and 112 provide a place for the user to place the user's fingers 152 and 154 during operation. Also, the indentaions 110 and 112 are located so that the user's fingers 152 and 154 rest on the cutting material 156 during use, which helps to locate and stabilize the portable punch during use.

The raised material 114 around the punch allows for the user to easily strike the punch during use. The grip may be made of a material that allows the grip to be easily slipped into place over a throat portion 113. A keyway may utilized between the throat 113 and the grip.

It will be appreciated that the punch may take a variety of configurations, as shown in FIG. 17, the punch is shown with a star punch.

Although this disclosure has been shown and described with respect to detailed embodiments, those skilled in the art will understand that various changes in form and detail may be made without departing form the scope of the claimed disclosure.

We claim:

1. A punch, comprising:
a cutting component that is configured to a shape;
a cutting component housing that houses the cutting component, the cutting component extending beyond the cutting component housing; and
a handle component extending from the cutting component housing for positioning the punch.

2. The punch of claim 1, wherein the cutting component is a die configured to a shape.

3. The punch of claim 2, wherein the die is made from steel rule.

4. The punch of claim 3, wherein the steel rule has a first end and a second end; and the first end and the second end are aligned.

5. The punch of claim 4, wherein the steel rule first end and second end are secured.

6. The punch of claim 5, wherein the steel rule first end and second end are secured by welding.

7. The punch of claim 1, wherein the cutting component housing includes an enlarged area.

8. The punch of claim 7, wherein the enlarged area generally encircles the cutting component.

9. The punch of claim 7, wherein the enlarged area encircles the cutting component.

10. The punch of claim 7, wherein the enlarged area is located adjacent to the cutting component.

11. The punch of claim 7, wherein the cutting component includes a plurality of enlarged areas.

12. The punch of claim 1, wherein the handle component includes a grip.

13. The punch of claim 12, wherein the grip comprises a material that absorbs shock.

14. The punch of claim 12, wherein the grip includes a portion adapted to position the user's fingers away from the cutting component.

15. The punch of claim 12, wherein the grip further includes a first indentation on a first side and a second indentation on a second side.

16. The punch of claim 15, wherein the first indentation and the second indentation are adapted to keep the user's fingers away from the cutting component.

17. The punch of claim 12, wherein the grip includes a raised portion.

18. The punch of claim 15, wherein the grip includes a raised portion, and the raised portion is defined by the first indentation and the second indentation.

19. The punch of claim 17, wherein the raised portion orients the punch when in use.

20. The punch of claim 18, wherein the raised portion orients the punch when in use.

21. A punch assembly, comprising:
a handle end and an opposite punch holding end;
the punch holding end holding a punch die which extends beyond a cutting side of the punch holding end; and
the handle end includes a sleeve with the thickness of the sleeve being approximately equal to one-half of the distance that the punch die extends from the cutting side of the punch holding end.

22. The punch assembly of claim 21, wherein the punch assembly includes indicia identifying the cutting side of the punch assembly.

23. The punch assembly of claim 21, wherein the punch die is made of steel rule.

24. A punch assembly, comprising:
a cutting component that is configured to a shape;
a cutting component housing that houses the cutting component, the cutting component extending beyond the cutting component housing;
a handle component extending from the cutting component housing for positioning the punch; and
a cutting pad adapted to be positioned so that the cutting pad is adjacent to the cutting component when in use.
